(19) United States
(12) Patent Application Publication
(10) Pub. No.: US 2017/0312151 A1
(43) Pub. Date: Nov. 2, 2017

(54) STRETCHER

(71) Applicants: ThyssenKrupp Marine Systems GmbH, Kiel (DE); ThyssenKrupp AG, Essen (DE)

(72) Inventors: Kai Schlösser, Kiel (DE); Robert Wirig, Nindorf (DE); Karsten Meier, Bornhöved (DE)

(73) Assignees: ThyssenKrupp Marine Systems GmbH, Kiel (DE); ThyssenKrupp AG, Essen (DE)

(21) Appl. No.: 15/523,161

(22) PCT Filed: Oct. 7, 2015
(86) PCT No.: PCT/EP2015/073086

§ 371 Date: Apr. 28, 2017

(30) Foreign Application Priority Data
Nov. 10, 2014 (DE) 10 2014 016 509.4

(51) Int. Cl. A61G 1/013; A61G 1/044; B63C 9/06; A61G 1/01; B63C 9/01

(52) U.S. Cl. CPC A61G 1/013; B63C 9/065; A61G 1/01; A61G 1/044; B63C 9/01

(57) ABSTRACT

A stretcher that can be rolled up may comprise at least two straps for securing a person in a longitudinal direction of the stretcher. The at least two straps for securing the person in the longitudinal direction of the stretcher are disposed such that the at least two straps are fastened above a first region. The first region may be configured to accommodate shoulders of the person. The stretcher may further comprises a foot plate that is adjustable in the longitudinal direction of the stretcher. In addition, a deployable buoyancy device may be mounted on the stretcher. The deployable buoyancy device may be fastened in a second region on the stretcher, wherein the second region is configured to accommodate the person's neck. The deployable buoyancy device may have a tubular configuration, and the deployable buoyancy device may be connected in the second region to the at least two straps for securing the person in the longitudinal direction.”

The invention relates to a stretcher for rescuing persons from spatially confined areas, in particular for rescuing persons at sea.

Many stretchers are known from the prior art. Stretchers generally comprise a system of bars or a basin giving the stretcher stiffness. In this way, a person can easily be placed on the stretcher and transported in a stable position. However, in confined environments, it may be impossible to store and to move a fixed stretcher, which usually has a length of more than 2 m and a width of more than 50 cm. In ships, for example, particularly in warships, space is often very limited, and therefore a conventional stretcher cannot be used.

Moreover, flexible stretchers are known. These are designed like a cloth and are thus flexible. They can be tightly packed, in particular rolled up, and are therefore easy to store and to transport. Stretchers of this kind are used, for example, in mountain rescue. To transport a person, they can then be rolled longitudinally half way round the person to be rescued, such that the person is stabilized in the stretcher. For this purpose, the stretcher is secured with a series of transverse belts which, for example, extend across the chest, abdomen and legs of the person. Such stretchers generally comprise six handles, three on the right and three on the left, respectively in the region of the shoulders, in the middle and at the foot end. In this way, six rescuers are able to easily carry the person in the stretcher. For this purpose, however, it is necessary that the rescuers have room to stand on the right and left of the stretcher.

When rescuing a person from a ship, in particular from a submarine, it is generally necessary to evacuate this person quickly. Such a person is usually evacuated by helicopter to another ship with suitable medical facilities or to a hospital on land. For this purpose, it is necessary to convey the person from on board the ship to on board the helicopter. In the case of ships that have no landing arrangements for helicopters, for example in the case of submarines, the person has to be evacuated by rope winch.

The object of the invention is to make available a stretcher that allows a person to be quickly rescued from a spatially confined environment, particularly at sea. The object of the invention is in particular to make available a stretcher which ensures the safety of the person and which stabilizes this person as much as possible, in order to prevent further injuries.

The object is achieved by a stretcher having the features set forth in claim 1. Advantageous developments will become clear from the dependent claims, from the following description and from the drawings.

The stretcher according to the invention can be rolled up. In this way, the stretcher can also be transported through tight spaces, for example bulkheads. The stretcher comprises at least two straps for securing a person in the longitudinal direction of the stretcher. The straps for securing a person in the longitudinal direction of the stretcher are arranged such that the straps are fastened above a first region, wherein the first region is designed to accommodate the shoulders of the person on the stretcher. The straps prevent the person from slipping on the stretcher in the longitudinal direction of the stretcher during transport. On the one hand, slipping can result in further injuries, particularly in cases where damage to the spinal column is present or suspected. On the other hand, slipping of the person would change the weight distribution on the stretcher, which can likewise endanger the person and possibly also the rescuers. A deployable buoyancy device is mounted on the stretcher. In the deployed state, a deployable buoyancy device generates buoyancy, in order to avoid the person drowning. Examples of deployable buoyancy devices are inflatable life jackets, inflatable buoyancy bodies or deployable life rafts. In the simplest case, deployment is effected by inflation or air intake. The deployable buoyancy device is fastened in a second region on the stretcher, wherein the second region is designed to accommodate a person's neck, and the deployable buoyancy device is of a tubular configuration in the state when not yet deployed. This has the advantage that the deployable buoyancy device can be readily integrated in the stretcher. The tubular deployable buoyancy device is advantageously arranged such that the person comes to lie with the neck more or less centrally on the buoyancy device. This has the great advantage that a person does not have to be additionally fitted with a life jacket, which is sometimes not possible if said person has suffered possibly injury to the cervical region and is wearing a suitable neck support. In the second region, and possibly also in a third region, said third region being designed to accommodate the shoulders, the deployable buoyancy device is connected to the straps for securing a person in the longitudinal direction. In this way, the secure positioning of the buoyancy device in the area of the person's head is ensured without additional handling maneuvers being needed during the rescue and with no additional strain on the person, as a result of which additional impairment of the state of health is reduced to a minimum. The buoyancy device is arranged such that the buoyancy device lies directly against a person lying on the stretcher. This is ensured by the fact that the straps for securing a person in the longitudinal direction lie against the person, and the buoyancy device is connected to the straps for securing a person in the longitudinal direction.

In the context of this invention, tubular is to be understood as meaning any elongate and movable shape, and tubular also expressly includes shapes that are not hollow on the inside or hollowed out.

It is particularly advantageous that the stretcher according to the invention can be used not only to transport a person but also to house a person. For example, housing may be needed if, for example between rescuing the person and onward transportation, it is necessary for example to await the arrival of a rescue vehicle, for example a helicopter. Housing an injured person may itself be a problem specifically in submarines. On board a submarine, an injured person is usually placed on the dining table in the mess and held there on wooden spars measuring about 3 cm in height. The injured person may fall when the submarine rolls. After the person has been rescued in the stretcher according to the invention, the person is able to remain in the stretcher and thus be safely housed in the mess, for example, or tended to where necessary. Particularly preferably, the stretcher according to the invention is for this purpose fastened to the ceiling of the ship room, for example of the mess, via ropes or other fastening means.

In a further embodiment of the invention, the stretcher can be integrated in another rigid stretcher. Rescue vehicles such as ambulances or helicopters typically comprise a rigid stretcher. This rigid stretcher is needed in order to connect the stretcher safely to the rescue vehicle. The rigid stretcher is a conventional rigid stretcher which, in particular, does not need to comprise a deployable buoyancy device and usually does not comprise this. In order to ensure that a person on the stretcher is subjected to as little discomfort as possible caused by shifting, this person along with the stretcher according to the invention is placed onto the rigid stretcher and secured there. For this purpose, the stretcher according to the invention preferably comprises elements by which the stretcher can be secured on the rigid stretcher.

In a further embodiment of the invention, the stretcher comprises a foot plate, wherein the foot plate is adjustable in the longitudinal direction of the stretcher. A foot plate is suitable for additionally stabilizing the person on the stretcher, particularly if the stretcher is used on a slope or perpendicularly. This is advantageous, for example, when the person is to be extricated through the turret of a submarine and then picked up by a helicopter. The foot plate, in addition to the straps, ensures the stabilization of the person on the stretcher.

In a further embodiment of the invention, the stretcher comprises rod-shaped or plate-shaped stiffening elements. The stiffening elements are oriented transversely with respect to the longitudinal direction of the stretcher. The advantage of this embodiment is, on the one hand, that the stretcher can be very easily rolled up in the longitudinal direction. On the other hand, the stiffening elements prevent rolling up in the longitudinal direction as soon as the stretcher is rolled in the transverse direction onto the person and stabilizes same. Particularly in the case of vertical transport or in the case of transport on a rope, for example when lifting into a hovering helicopter, this leads to a stabilization of the person's position. The more stably the person is secured in the stretcher, the less chance there is of further deterioration of the person's state of health.

In a further embodiment of the invention, the ends of the tubular deployable buoyancy device are connectable in front of the person's chest. Since the deployable buoyancy device is connected in the second region to the straps for securing a person in the longitudinal direction, the ends come to lie in the chest region or abdominal region of a person lying on the stretcher. These ends can be easily connected to each other, for example by means of a click closure or a carabiner, without the person being subjected to additional stresses. The action of the buoyancy device in the deployed state is improved by the connection, and the buoyancy is optimized particularly in the area of the person's head. Drowning can be prevented most efficiently in this way.

In a further embodiment of the invention, the stretcher comprises handles at the head end and at the foot end. The stretcher is stabilized sufficiently in the longitudinal direction by the person secured on the stretcher such that the latter can be carried by two persons, one at the head end and one at the foot end. Although this is disadvantageous compared to the conventional way in which the stretcher is carried by six rescuers, it nevertheless also allows a person to be transported in spatially confined areas where there is no room for anyone next to a stretcher. In particularly confined spaces, the stretcher can also be pulled across the ground by just one person. For this purpose, the stretcher particularly preferably also comprises stiffening elements, since in this way a person is stabilized even when being pulled by just one person.

In a further embodiment of the invention, the stretcher comprises transverse belts for securing the person. The stretcher preferably has two to twelve transverse belts, particularly preferably four to six transverse belts. The transverse belts are arranged in such a way that they as it were roll the stretcher around the person. The transverse belts are preferably designed such that the length is variable, in order to allow the person to be safely secured independently of the size of the person.

In a further embodiment of the invention, the deployable buoyancy device, in the chest region of a person lying on the stretcher, comprises tetrahedral buoyancy bodies in the deployed state. A chest belt particularly reliably prevents a situation in which the buoyancy device changes position in the deployed state and in contact with water, in particular slipping over the person's head. Additional fastening of an additional chest belt would place an additional strain on the patient. The chest belt is therefore connected to a transverse belt. In this way, the overall strain on the person is kept to a minimum.

In a further embodiment of the invention, the deployable buoyancy device, in the chest region of a person lying on the stretcher, comprises tetrahedral buoyancy bodies in the deployed state. Tetrahedral buoyancy bodies have proven particularly safe in the area of life jackets and avoid situations where quite small waves can wash over the head of the person in the stretcher.

In a further embodiment of the invention, the stretcher comprises several loops arranged in the longitudinal direction of the stretcher. The loops are arranged centrally in the transverse direction of the stretcher. The deployable buoyancy device can be fastened to a loop by means of a Velcro-type closure piece. In this way, the deployable buoyancy device can be adjusted quickly and easily in height, for example before a particularly large or particularly small person is to be placed on the stretcher.

In a further embodiment of the invention, the deployable buoyancy device self-deploys upon contact with water. Since the person to be rescued is not normally intended to come into contact with water, it is not necessary, but a hindrance, to deploy the buoyancy device after securing the person to the stretcher. However, since the person is secured and may possibly be unconscious, it is not possible for the person to deploy the buoyancy device as soon as he or she comes unexpectedly into contact with water. It is true that, during the automatic deployment, the person is subjected to forces that may cause a deterioration in the state of health, but drowning of said person is to be avoided at all costs.

In a further embodiment of the invention, the deployable buoyancy device comprises a first sector and a second sector, wherein the first sector is deployed first during the deployment and the second sector is deployed subsequently thereto. For example, the sector on the person's right is deployed first, and the sector on the person's left is deployed thereafter. The advantage of this embodiment is that the person is in a supine position and therefore has his or her face directed upward.

In a further embodiment of the invention, the stretcher can be rolled up in the longitudinal direction. A compact package is made possible in this way, and the stretcher can be quickly unrolled in an emergency and thus made ready for use.

In a further embodiment of the invention, the rolled-up stretcher forms a backpack. In this way, the stretcher can be easily transported in the rolled-up state.

In a further aspect, the invention relates to the use of a stretcher according to the invention for rescue from a ship. The ship is in particular a submarine.

In a further aspect, the invention relates to the use of a stretcher according to the invention for rescue from caves. Caves, in particular natural caves, are often confined and sometimes comprise areas that are filled with water. Rescuing persons from caves is therefore often very difficult.

The stretcher according to the invention is explained in more detail below with reference to an illustrative embodiment depicted in the drawings.

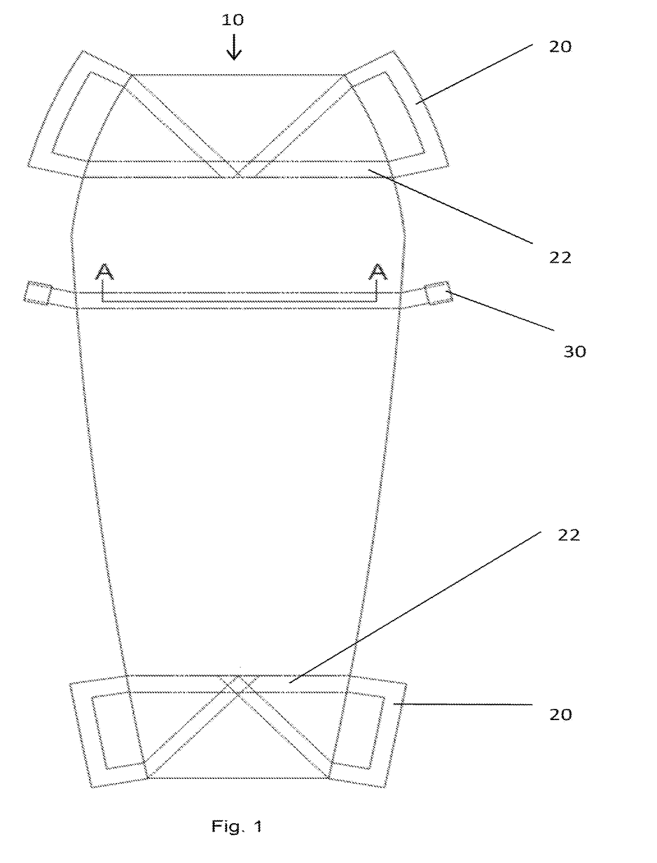

FIG. 1: schematic rear view of a stretcher

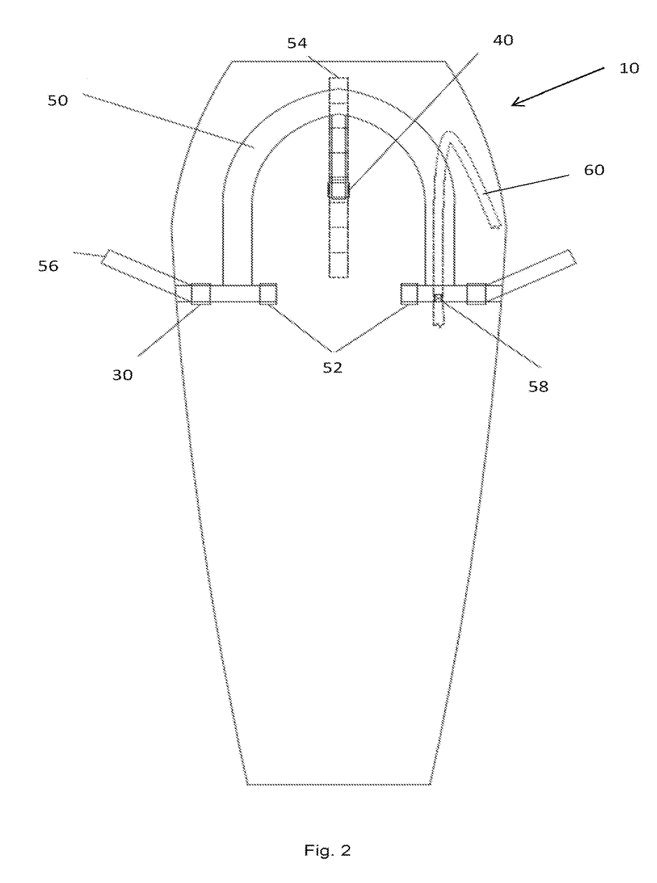

FIG. 2: schematic plan view of a stretcher

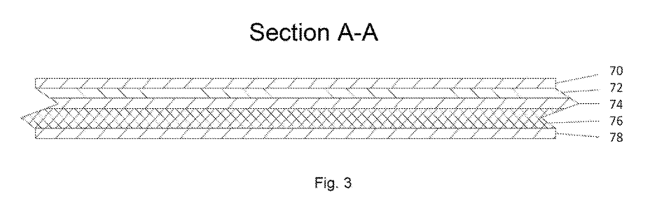

FIG. 3: schematic cross section along A-A

FIG. 1 shows an illustrative embodiment of a stretcher 10 according to the invention. The stretcher 10 has handles composed of belt strap 20, wherein these handles preferably run in the handle region through a plastic tube, particularly preferably a woven tube. The advantage of a tube in the handle region is the round shape of the tube, which can be gripped comfortably and securely, without the belt exerting punctiform loads on the hands of the rescuers. The belt strap 22 is sewn onto the stretcher 10. The sewing is preferably in the form shown in FIG. 1. The belt runs continuously on the side directed toward the middle of the stretcher; the two other ends are sewn onto the stretcher 10 such that they impinge more or less centrally on the continuous belt strap and are here sewn onto it. This ensures a particularly efficient transmission of force from the handle 20 to the stretcher 10 via the belt and prevents the handles composed of belt strap 20 tearing off and prevents the stretcher from being damaged. Moreover, a further belt strap is sewn onto the stretcher in the region for accommodating the chest region of a person and comprises buckles 30. When a person is placed onto the stretcher 10, the buckles 30 are connected to each other. In this way, the stretcher 10 is rolled laterally around the person and thereby stabilizes the person.

FIG. 2 shows the stretcher 10 in a schematic plan view. A deployable buoyancy device 50 is mounted on the stretcher 10 and is connected to the stretcher 10 in a height-adjustable manner via an adjustable fastener 54 and a fastening tab 40. The adjustable fastener 54 is configured, for example, in the form of a Velcro tape. In this way, the position of the deployable buoyancy device can be adapted easily and quickly to the height of a person who is to be placed on the stretcher 10. By means of closure pieces 52, the deployable buoyancy device 50 can be closed in front of the chest of a person placed on the stretcher 10 and can thus be fixed in the correct position. The deployable buoyancy device 50 is likewise connected to the stretcher 10 via the buckles 30, wherein the belt strap 56 on the buckle 30 can be used to adapt the length to the chest circumference of a person lying on the stretcher 10. Moreover, the stretcher 10 comprises two shoulder belts 60, with only a part of one shoulder belt 60 being shown in the diagram. In the present embodiment, a shoulder belt 60 is a strap for securing a person in the longitudinal direction of the stretcher. The shoulder belt 60 is connected to the deployable buoyancy device 50 at the seam 58. In this way, the correct position of the deployable buoyancy device 50 is ensured, since a person lying on the stretcher 10 is secured in the longitudinal direction of the stretcher 10 by the shoulder belts 60. The deployable buoyancy device 10 is of a tubular configuration and, as shown, is preferably fastened in a U shape on the stretcher 10.

FIG. 3 shows a schematic cross section along the line A-A according to FIG. 3. The stretcher 10 has an upper layer 70 and a lower layer 78. The upper layer 70 is worked in such a way that it can be easily cleaned, since an injured person comes to lie on the upper layer 70 during the use of the stretcher 10. The lower layer 78 is particularly resistant to tearing, since the lower layer 78 will possibly be dragged across the ground during transport, particularly in confined areas. The upper layer 70 and the lower layer 78 can also be made from the same material, provided that this material satisfies both requirements. Between the upper layer 70 and the lower layer 78 there is an inner pocket 74. Between the inner pocket 74 and the lower layer 78 there is a stiffening element 76. The stiffening element 76 is, for example, a plastic sheet with a thickness of between 0.2 and 10 mm. The stiffening element 76 can be made, for example, of polyethylene, polypropylene, polyvinyl chloride, polytetrafluoroethylene or acrylonitrile-butadiene-styrene copolymer. All of the belt straps 72 are particularly preferably sewn between the upper layer 70 and the inner pocket 74. In this way, a routing of the belt straps 72 is possible which lies neither on the upper layer 70, where they can be uncomfortable for a person lying on the stretcher 10 and can make cleaning of the upper layer 70 difficult, nor on the lower layer 78, as a result of which pulling the stretcher 10 across the ground or in particular through a bulkhead is not made difficult. Moreover, this permits a particularly efficient transmission of force between belt strap 72 and stretcher 10.

### REFERENCE SIGNS

10 Stretcher
20 Handle composed of belt strap
22 Sewn belt strap
30 Buckle
40 Fastening tab
50 Deployable buoyancy device
52 Closure piece
54 Adjustable fastener
56 Belt strap
58 Seam
60 Shoulder belt
70 Upper layer
72 Belt strap
74 Inner pocket
76 Stiffening element
78 Lower layer

1.-15. (canceled)

16. A stretcher that can be rolled up, the stretcher comprising:
at least two straps for securing a person in a longitudinal direction of the stretcher, the at least two straps being disposed such that the at least two straps are fastened above a first region that accommodates shoulders of the person; and
a deployable buoyancy device mounted on the stretcher, the deployable buoyancy device being fastened in a second region on the stretcher that accommodates a neck of the person, wherein the deployable buoyancy device has a tubular configuration and is connected in the second region to the at least two straps, wherein the deployable buoyancy device is configured to lie directly against the person.

17. The stretcher of claim 16 further comprising a foot plate that is adjustable in the longitudinal direction of the stretcher.

18. The stretcher of claim 16 further comprising stiffening elements that are either rod-shaped or plate-shaped, wherein the stiffening elements are oriented transversely with respect to the longitudinal direction of the stretcher.

19. The stretcher of claim 16 wherein ends of the deployable buoyancy device are connectable in front of a chest of the person.

20. The stretcher of claim 16 further comprising handles disposed at a head end and at a foot end of the stretcher.

21. The stretcher of claim 16 further comprising transverse belts for securing the person.

22. The stretcher of claim 21 wherein the deployable buoyancy device comprises a chest belt that is connected to at least one of the transverse belts.

23. The stretcher of claim 16 wherein in a deployed state the deployable buoyancy device comprises tetrahedral buoyancy bodies in a chest region of the person.

24. The stretcher of claim 16 further comprising loops disposed in the longitudinal direction of the stretcher.

25. The stretcher of claim 24 wherein the loops are disposed centrally in a transverse direction of the stretcher, wherein the deployable buoyancy device can be fastened to at least one of the loops with a Velcro-type closure piece.

26. The stretcher of claim 16 wherein the deployable buoyancy device is configured to self-deploy upon contact with water.

27. The stretcher of claim 26 wherein the deployable buoyancy device comprises a first sector and a second sector, wherein during deployment of the deployable buoyancy device the first sector is deployed before the second sector.

28. The stretcher of claim 16 wherein the stretcher can be rolled up in the longitudinal direction.

29. The stretcher of claim 28 wherein the rolled-up stretcher forms a backpack.

30. The stretcher of claim 16 configured to rescue the person from a ship.

31. The stretcher of claim 16 configured to rescue the person from a submarine.
